(19) United States
(12) Patent Application Publication
(10) Pub. No.: US 2020/0134526 A1
(43) Pub. Date: Apr. 30, 2020

(54) RESOURCE PLANNING APPARATUS AND RESOURCE PLAN VISUALIZATION METHOD

(71) Applicant: HITACHI, LTD., Tokyo (JP)

(72) Inventors: Noriyuki HAGA, Tokyo (JP); Masayoshi ISHIBASHI, Tokyo (JP); Toshiyuki NAKAMURA, Tokyo (JP)

(73) Assignee: HITACHI, LTD., Tokyo (JP)

(21) Appl. No.: 16/576,488

(22) Filed: Sep. 19, 2019

(30) Foreign Application Priority Data
Oct. 24, 2018 (JP) 2018-199962

(51) Int. Cl. G06Q 10/06

(52) U.S. Cl. CPC G06Q 10/06313

(57) ABSTRACT

A resource planning apparatus includes a resource expanding unit configured to expand processes necessary for producing a product and resource capabilities necessary for resources to execute the processes, a resource allocation scheme generating unit configured to allocate resources having the resource capabilities expanded by the resource expanding unit to the processes, and a production plan devising unit configured to devise a production plan of the product on the basis of the resources allocated to the processes.

### CROSS-REFERENCE TO RELATED APPLICATIONS

This application is based upon and claims the benefit of priority from Japanese Patent Application No. 2018-199962, filed on Oct. 24, 2018; the entire contents of all of which are incorporated herein by reference.

### FIELD

The present invention relates to a resource planning apparatus and a resource plan visualization method for devising a resource plan necessary for production and provision of services in businesses.

### BACKGROUND

In businesses, production must be carried out in an efficient manner by appropriately allocating resources such as workers and equipment necessary for production and provision of services. On the other hand, since capabilities of resources such as workers improve through education, it is important to device a resource plan including such changes in resources.

As a conventional technique for achieving such ends, for example, Japanese Patent Application Publication No. 2012-174098 discloses a work plan creating apparatus which, in consideration of a training period indicating a period necessary for a worker to learn how to perform work, simulates a work completion timing in a case where a training completion timing is applied.

### SUMMARY

However, since the technique disclosed in Japanese Patent Application Publication No. 2012-174098 is premised on contents of work in each process being fixed, the technique offers no means other than training, over time, a worker capable of accommodating the contents of work.

The present invention has been made in consideration of the circumstance described above, and an object thereof is to provide a resource planning apparatus and a resource plan visualization method which enable flexibility of a resource plan to be improved.

In order to achieve the object described above, a resource planning apparatus according to a first perspective includes: a resource expanding unit configured to expand processes necessary for producing a product and resource capabilities necessary for resources to execute the processes; a resource allocation scheme generating unit configured to allocate resources having the resource capabilities expanded by the resource expanding unit to the processes; and a production plan devising unit configured to devise a production plan of the product on the basis of the resources allocated to the processes.

According to the present invention, flexibility of a resource plan can be improved.

### BRIEF DESCRIPTION OF THE DRAWINGS

FIG. 1 is a block diagram showing a configuration of a resource planning apparatus according to a first embodiment;

FIG. 2 is a diagram showing an example of a product resource expansion table stored in the resource planning apparatus according to the first embodiment;

FIG. 3 is a diagram showing an example of a product resource expansion table after adjustment which is stored in the resource planning apparatus according to the first embodiment;

FIG. 4 is a diagram showing an example of resource capability data before, FIG. 4A, and after, FIG. 4B, adjustment which is stored in the resource planning apparatus according to the first embodiment;

FIG. 5 is a diagram showing an example of a resource allocation scheme of the resource planning apparatus according to the first embodiment;

FIG. 6 is a diagram showing an example of a production plan of the resource planning apparatus according to the first embodiment;

FIG. 7 is a diagram showing an example of a resource unit price table which is used to determine a KPI of the resource planning apparatus according to the first embodiment;

FIG. 8 is a diagram showing an example of a resource allocation scheme after adjustment of a production plan of the resource planning apparatus according to the first embodiment;

FIG. 9 is a diagram showing a display example of a production plan KPI of the resource planning apparatus according to the first embodiment;

FIG. 10 is a diagram showing an example of a production plan adjustment pattern of the resource planning apparatus according to the first embodiment;

FIG. 11 is a flow chart showing operations of the resource planning apparatus according to the first embodiment;

FIG. 12 is a diagram showing a display example of a production plan KPI of a resource planning apparatus according to a second embodiment; and

FIG. 13 is a block diagram showing a hardware configuration example of the resource planning apparatus shown in FIG. 1.

### DETAILED DESCRIPTION OF THE EMBODIMENT

Embodiments will be described with reference to the drawings. It should noted that the embodiments described below are not intended to limit the invention as set forth in the accompanying claims and that all of the elements described in the embodiments and combinations thereof are not necessarily essential to solutions proposed by the invention.

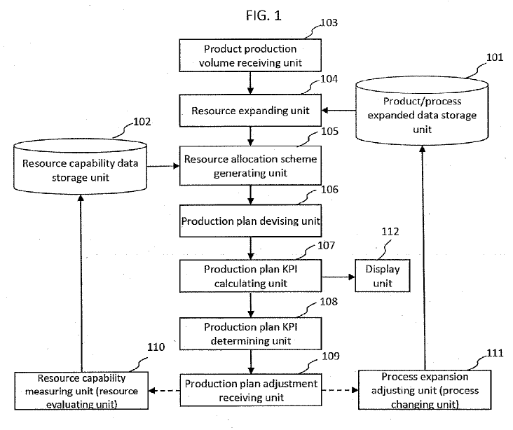

FIG. 1 is a block diagram showing a configuration of a resource planning apparatus according to a first embodiment.

In FIG. 1, the resource planning apparatus includes a product/process expanded data storage unit 101, a resource capability data storage unit 102, a product production volume receiving unit 103, a resource expanding unit 104, a resource allocation scheme generating unit 105, a production plan devising unit 106, a production plan KPI (Key Performance Indicator) calculating unit 107, a production plan KPI determining unit 108, a production plan adjustment receiving unit 109, a resource capability measuring unit 110, and a process expansion adjusting unit 111.

The product/process expanded data storage unit 101 stores a product resource expansion table. Processes necessary for producing a product and resource capabilities necessary for resources to execute the processes are registered in the product resource expansion table. Each resource may be a worker who executes a process or a robot or automated equipment that automatically executes work. In addition, a device such as a powered exoskeleton may be registered as work auxiliary machinery and, when a capability level of a worker is insufficient, the work auxiliary machinery and the worker may be allocated at the same time. A resource capability is, for example, a work capability necessary for executing each process. A resource capability is a capability in accordance with a process type such as a machining process, an assembly process, or an inspection process. The resource capability data storage unit 102 stores data indicating a resource capability of a resource for executing a process necessary for producing the product.

The product production volume receiving unit 103 receives a production volume of a product that needs to be produced. In this case, the product production volume receiving unit 103 receives a product number and a delivery date together with the production volume of the product.

The resource expanding unit 104 refers to a product resource expansion table stored in the product/process expanded data storage unit 101 on the basis of the product number received by the product production volume receiving unit 103. In addition, on the basis of a reference result of the product resource expansion table, the resource expanding unit 104 expands processes necessary for producing the product and resource capabilities necessary for resources to execute the processes. In this case, the resource expanding unit 104 also expands time necessary for producing the product and the like.

The resource allocation scheme generating unit 105 searches the resource capability data storage unit 102 on the basis of the resource capabilities necessary for producing the product as expanded by the resource expanding unit 104 and retrieves resources having the resource capabilities necessary for executing the processes. In addition, the resource allocation scheme generating unit 105 allocates the resources having the resource capabilities expanded by the resource expanding unit 104 to the processes expanded by the resource expanding unit 104.

The production plan devising unit 106 devises a production plan in a case where resources allocatable by the resource allocation scheme generating unit 105 are allocated to the processes. In the Production plan, performance dates of the work necessary for producing the designated production volume are determined. Accordingly, data indicating the number of working days of the resources is generated. At this point, a plurality of production draft plans are generated in accordance with combinations of resources to be allocated, performance dates of work, and the like.

When resources and times at which the resources engage in the processes are determined on the basis of the production plan generated by the production plan devising unit 106, the production plan KPI calculating unit 107 calculates a primary performance of the production plan on the basis of the data. The primary performance is referred to as a KPI. The KPI differs depending on the business or the line of business. The KPI can include at least any one of labor cost, product cost, a production volume, equipment/management cost, and total cost.

The production plan KPI determining unit 108 determines whether or not the KPI calculated by the production plan KPI calculating unit 107 is equal to or larger than a target value. When the KPI includes a plurality of items, a target value can be set for each item.

The production plan adjustment receiving unit 109 receives a change or a determination of the production plan on the basis of a determination result of the KPI. The determination result of the KPI may be input by the production plan KPI determining unit 108 to the production plan adjustment receiving unit 109 or may be manually input to the production plan adjustment receiving unit 109.

A display unit 112 displays KPIs calculated by the production plan KPI calculating unit 107 with respect to the plurality of production draft plans and the like. In addition, when there is a production draft plan having reached the KPI expected as the production plan, a user designates the production draft plan, in which case the production plan adjustment receiving unit 109 receives a determination of the production draft plan designated by the user. Alternatively, when there is a portion not having reached the KPI expected as the production plan, the user instructs an adjustment of the production plan, in which case the production plan adjustment receiving unit 109 receives an adjustment of the production plan.

For example, when the labor cost is higher than expected, the Production plan adjustment receiving unit 109 receives a labor cost reduction request and instructs a readjustment of process expansion or a readjustment of resources on the basis of a labor cost reduction pattern.

The resource capability measuring unit 110 includes a measuring apparatus for measuring a work capability of a worker and the like. In addition, the resource capability measuring unit 110 includes a resource evaluating unit which evaluates a resource capability on the basis of a measurement result of a work capability. The measuring apparatus includes an information terminal such as a personal computer, a tablet, or a smartphone and sensors that measure a movement of a person, and a work capability is measured as an object person performs an operation or moves on the basis of instructions from the information terminal. Tools necessary for the work are also provided as necessary, in which case the work capability when using such tools is measured. In addition, the information terminal also makes inquiries regarding the work and measures knowledge, experience, and the like. The resource capability measuring unit 110 evaluates a resource capability on the basis of a measurement result of the work capability and registers the resource capability in the resource capability data storage unit 102.

It should be noted that, while the resource capability measuring unit 110 is capable of remeasuring a resource capability after a production plan adjustment is received and registering the resource capability in the resource capability data storage unit 102, the resource capability measuring unit 110 may measure a resource capability before a production plan adjustment is received and register the resource capability in the resource capability data storage unit 102.

Specific examples of a resource capability include a lifting force, agility, finger strength, flexibility, and leg strength which can respectively be measured by methods such as those described below. Lifting force is obtained by measuring how many times a target object with a certain weight can be lifted within a specified time. Agility is obtained by applying a certain resistance force to an arm and measuring how many times the arm can be moved left and right within a specified time. Finger strength is obtained by measuring a pushing force exerted by a finger or by measuring a force by which a target object is grasped and rotated. Flexibility is obtained by measuring an angle of the waist when bending forward. Leg strength is obtained by measuring time it takes to walk a certain distance. These are merely examples and items to be measured are to be added in accordance with necessary work.

When an adjustment of the production plan is received by the Production plan adjustment receiving unit 109, the process expansion adjusting unit 111 changes data of the product/process expanded data storage unit 101 as the adjustment of the production plan and enables allocation of resources to be changed. When changing the allocation of resources, for example, processes may be divided by preparing a separate product resource expansion table or work may be divided using an automation tool for production work expansion from design information of the product. Alternatively, a plurality of divided processes may be integrated into a single process.

As described above, the resource planning apparatus is capable of expanding a resource capability necessary for a resource to execute a process, retrieve a resource having the resource capability expanded for the process, and allocate the retrieved resource to the process. As this point, when the resource capability of the resource allocated to the process is insufficient, the resource planning apparatus can re-retrieve a resource having the resource capability necessary for the process and allocate the re-retrieved resource to the process. For example, when a resource capability of a first resource allocated to a process A is insufficient, the resource planning apparatus can allocate a second resource that differs from the first resource to the process A. Therefore, even when the resource capability of the first resource allocated to the process A is insufficient, a production plan can be devised without having to wait for a training period of the first resource to expire and flexibility of the resource plan can be improved.

Hereinafter, operations of the resource planning apparatus shown in FIG. 1 will be described in concrete terms on the basis of specific examples of the product resource expansion table stored in the product/process expanded data storage unit 101 and the resource capability data stored in the resource capability data storage unit 102.

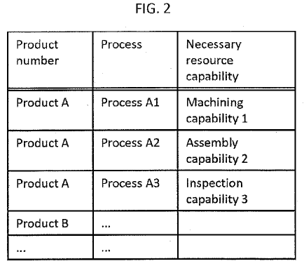

FIG. 2 is a diagram showing an example of the product resource expansion table stored in the resource planning apparatus according to the first embodiment.

Products A and B are registered as product numbers in the product resource expansion table shown in FIG. 2. In addition, the product resource expansion table shows that processes A1 to A3 are necessary as processes in order to produce a product of which the product number is product A. Furthermore, in the product resource expansion table, a capability required for a resource to execute the process A1 is defined as a machining capability 1, a capability required for a resource to execute the process A2 is defined as an assembly capability 2, and a capability required for a resource to execute the process A3 is defined as an inspection capability 3.

In this case, for example, when the product production volume receiving unit 103 shown in FIG. 1 receives production of the product A, the resource expanding unit 104 expands processes necessary for producing the product A into processes A1 to A3 on the basis of the product resource expansion table shown in FIG. 2. In addition, the resource expanding unit 104 expands resource capabilities necessary for producing the product A into the machining capability 1 necessary for the process A1, the assembly capability 2 necessary for the process A2, and the inspection capability 3 necessary for the process A3.

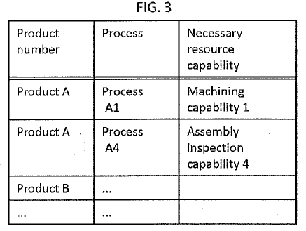

FIG. 3 is a diagram showing an example of the product resource expansion table after adjustment which is stored in the resource planning apparatus according to the first embodiment.

Products A and B are registered as product numbers in the product resource expansion table shown in FIG. 3. In addition, the product resource expansion table shows that processes A1 and A4 are necessary as processes in order to produce a product of which the product number is product A. Furthermore, in the product resource expansion table, a capability required for a resource to execute the process A1 is defined as the machining capability 1 and a capability required for a resource to execute the process A4 is defined as an assembly inspection capability 4.

When an adjustment of the production plan is received by the Production plan adjustment receiving unit 109, for example, the process expansion adjusting unit 111 shown in FIG. 1 generates the product resource expansion table shown in FIG. 3 and stores the product resource expansion table in the product/process expanded data storage unit 101.

In addition, the resource expanding unit 104 expands processes necessary for producing the product A into processes A1 and A4 on the basis of the product resource expansion table shown in FIG. 3 Furthermore, the resource expanding unit 104 expands resource capabilities necessary for producing the product A into the machining capability 1 necessary for the process A1 and the assembly inspection capability 4 necessary for the process A4.

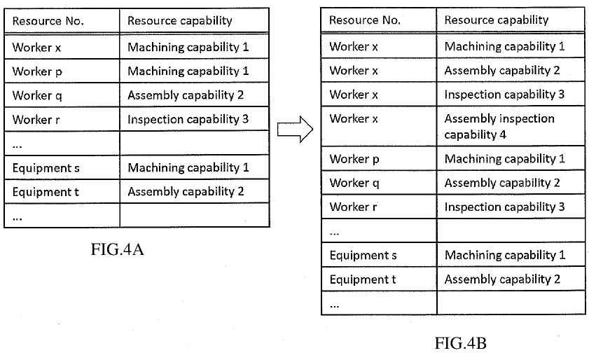

FIG. 4 is a diagram showing an example of resource capability data before and after adjustment which is stored in the resource planning apparatus according to the first embodiment.

Let us assume that, before production plan adjustment is received, resource capability data shown in FIG. 4A is stored in the resource capability data storage unit 102 shown in FIG. 1. Workers x, p, q, and r and equipment s and t are registered as resource numbers in the resource capability data. In addition, it is registered in the resource capability data that the workers x and p and the equipment s have the machining capability 1 as a resource capability, the worker q and the equipment t have the assembly capability 2 as a resource capability, and the worker r has the inspection capability 3 as a resource capability.

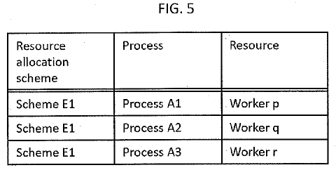

FIG. 5 is a diagram showing an example of a resource allocation scheme of the resource planning apparatus according to the first embodiment.

Let us assume that, for example, the resource expanding unit 104 shown in FIG. 1 has expanded processes necessary for producing the product A into processes A1 to A3 on the basis of the product resource expansion table shown in FIG. 2. In this case, by referring to the resource capability data shown in FIG. 4A, the resource allocation scheme generating unit 105 searches for resources having the machining capability 1 necessary for the process A1, the assembly capability 2 necessary for the process A2, and the inspection capability 3 necessary for the process A3.

For example, by referring to the resource capability data shown in FIG. 4A, the resource allocation scheme generating unit 105 retrieves the worker p as a resource having the machining capability 1, the worker q as a resource having the assembly capability 2, and the worker r as a resource having the inspection capability 3. In addition, as shown in FIG. 5, the resource allocation scheme generating unit 105 generates a resource allocation scheme E1 in which the worker p is allocated to the process A1, the worker q is allocated to the process A2, and the worker r is allocated to the process A3.

Once the resource allocation scheme E1 shown in FIG. 5 is generated, the production plan devising unit 106 devises a production plan of the product A on the basis of the resource allocation scheme E1.

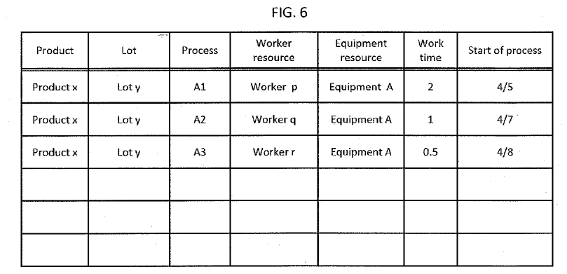

FIG. 6 is a diagram showing an example of a production plan of the resource planning apparatus according to the first embodiment.

In FIG. 6, when a product x is produced in a production lot y, in an initial process A1, work is performed by the worker resource p and the equipment A is used as the equipment resource while the work is being performed. A work time of the work is 2 unit times and a start of the process is set to April 5. In a next process A2, work is performed by the worker resource q and the equipment A is used as the equipment resource while the work is being performed. A work time of the work is 1 unit time and a start of the process is set to April 7. In a next process A3, work is performed by the worker resource rand the equipment A is used as the equipment resource while the work is being performed. A work time of the work is 0.5 unit times and a start of the process is set to April 8. In such a production plan, the production plan devising unit 106 devises the plan to avoid conflicting use of worker resources or equipment resources that may become constraints so that conflicts of worker resources or equipment resources do not occur.

Next, the production plan KPI calculating unit 107 calculates the KPI of a production plan of the product A with respect to the resource allocation scheme E1. For example, the production plan KPI calculating unit 107 calculates labor cost incurred in producing the product A as the KPI. The production plan KPI calculating unit 107 can refer to a resource unit price table in order to calculate the labor cost.

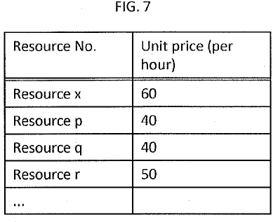

FIG. 7 is a diagram showing an example of the resource unit price table which is used to determine the KPI of the resource planning apparatus according to the first embodiment.

In the resource unit price table shown in FIG. 7, resources x, p, q, and r are registered as resource numbers and a unit price per hour is registered for each of the resources x, p, q, and r. In addition, by referring to the resource unit price table shown in FIG. 7, the production plan KPI calculating unit 107 can calculate the labor cost incurred in producing the product A.

Next, the production plan KPI determining unit 108 determines whether or not the KPI calculated by the production plan KPI calculating unit 107 is equal to or larger than a target value. At this point, let us assume that, for example, the labor cost of the production plan devised on the basis of the resource allocation scheme El is higher than expected. In this case, the production plan KPI determining unit 108 can instruct the production plan adjustment receiving unit 109 to change the production plan.

When the production plan adjustment receiving unit 109 receives a change to the production plan, the production plan adjustment receiving unit 109 instructs the process expansion adjusting unit 111 to readjust process expansion or instructs the resource capability measuring unit 110 to re-evaluate the resources.

Let us assume that, at this point, the process expansion adjusting unit 111 generates the product resource expansion table shown in FIG. 3 by readjusting process expansion. Let us also assume that, by remeasuring the work capability of the worker x, the resource capability measuring unit 110 has confirmed that the worker x has not only the machining capability 1 but also the assembly capability 2 and the inspection capability 3. At this point, the resource capability measuring unit 110 updates the resource capability data shown in FIG. 4A and adds the assembly capability 2, the inspection capability 3, and the assembly inspection capability 4 as resource capabilities of the worker x as shown in FIG. 4B.

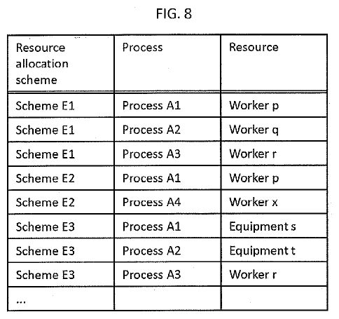

FIG. 8 is a diagram showing an example of a resource allocation scheme after adjustment of a production plan of the resource planning apparatus according to the first embodiment.

In FIG. 8, when the product resource expansion table shown in FIG. 3 is stored in the product/process expanded data storage unit 101 shown in FIG. 1 due to a readjustment of process expansion, the resource expanding unit 104 expands processes necessary for producing the product A into processes A1 and A4 on the basis of the product resource expansion table shown in FIG. 3. In addition, the resource expanding unit 104 expands resource capabilities necessary for producing the product A into the machining capability 1 necessary for the process A1 and the assembly inspection capability 4 necessary for the process A4.

Next, when the resource capability data shown in FIG. 4B is stored in the resource capability data storage unit 102 due to a remeasurement of work capability, the resource allocation scheme generating unit 105 searches for resources having the machining capability 1 necessary for the process A1 and the assembly inspection capability 4 necessary for the process A4 by referring to the resource capability data shown in FIG. 4B. In this case, once the resource allocation scheme generating unit 105 retrieves the worker p as a resource having the machining capability 1 necessary for the process A1 and the worker x as a resource having the assembly inspection capability 4 necessary for the process A4, the resource allocation scheme generating unit 105 generates a resource allocation scheme E2 in which the worker p is allocated to the process A1 and the worker x is allocated to the process A4 as shown in FIG. 8.

In the resource allocation scheme E2, since the worker x single-handedly executes, in the process A4, assembly and inspection necessary for producing the product A, the labor cost can be reduced as compared to the resource allocation scheme E1.

In order to further reduce the labor cost, the resource allocation scheme generating unit 105 can also allocate automated equipment as a resource. For example, by referring to the resource capability data shown in FIG. 4B, the resource allocation scheme generating unit 105 retrieves the equipment s as a resource having the machining capability 1, the equipment t as a resource having the assembly capability 2, and the worker r as a resource having the inspection capability 3. In addition, as shown in FIG. 8, the resource allocation scheme generating unit 105 generates a resource allocation scheme E3 in which the equipment s is allocated to the process A1, the equipment t is allocated to the process A2, and the worker r is allocated to the process A3.

Once the resource allocation schemes E2 and E3 are generated, the production plan devising unit 106 devises production plans of the product A on the basis of the resource allocation schemes E2 and E3 shown in FIG. 8. Next, the production plan KPI calculating unit 107 calculates the KPI of the production plan of the product A with respect to each of the resource allocation schemes E2 and E3.

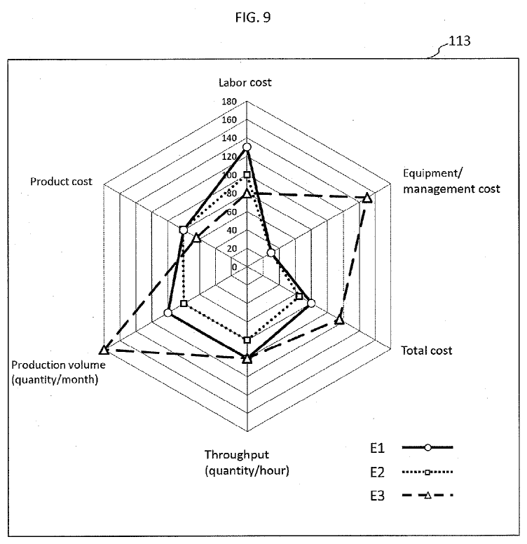

FIG. 9 is a diagram showing a display example of a production plan KPI of the resource planning apparatus according to the first embodiment.

The example shown in FIG. 9 indicates, as the KPI, labor cost as a cost incurred by worker resources to be allocated, equipment/management cost when equipment and the like are available as resources, total cost that is a sum of the labor cost and the equipment/management cost, a throughput that represents a quantity of products produced per hour, a production volume when the product is produced over a certain period of time such as a month, and product cost per one product when the product is produced over a certain period of time.

The labor cost is calculated as labor cost per one produced product x with respect to worker resources engaged during a production time T_{x,y} of the production lot y in which the product x is produced. An average value obtained by dividing a total sum of unit prices of the engaged worker resources and work engagement times by a quantity of products x produced in the production lot y=a lot production volume P_{x,y} is adopted as the labor cost. The worker resource unit price is a value determined by the capability of a worker resource. Unit prices are set in advance so as to set a high unit price when a worker resource has the capability of performing a plurality of work tasks and to set a low unit price when a worker resource is only capable of performing a simple work task. Labor cost CostH_{x,y} necessary for producing the product x in the production lot y can be given by the following equation:

$${CostH}_{x , y} = \frac{{\sum }_{j = 1}^{M} \{ {H}_{j} \times {T}_{x , y , j} \}}{{P}_{x , y}} \qquad [ Math . 1 ]$$

where

j: worker resource number,

M: total number of worker resources,

Hⱼ: unit price of worker resource number

T_{x,y,j}: work engagement time of engaged worker resource number j when producing product x in production lot y, and

P_{x,y}: quantity of products x produced in production lot y.

As the equipment/management cost, an average value obtained by dividing a sum of depreciation of equipment necessary for producing the product x and maintenance cost of the equipment being dependent on an operation time of the equipment by the production volume P_{x,y} of the product x is adopted. Labor cost CostM_{x,y} necessary for producing the product x in the production lot y can be given by the following equation:

$${CostM}_{x , y} = \frac{{\sum }_{k = 1}^{L} \{ {MG}_{k} \times {TG}_{k} + {MM}_{k} \times {TM}_{k} \}}{{P}_{x , y}} \qquad [ Math . 2 ]$$

where

k: equipment number,

L: total number of equipment,

MGₖ: depreciation per hour of equipment number k,

TGₖ: time during which equipment number k is occupied when producing product x,

MMₖ: maintenance cost per hour of equipment number k,

TMₖ: time of operation of equipment number k when producing product x, and

P_{x,y}: quantity of products x produced in production lot y.

The product cost is calculated on the basis of prices and numbers of parts necessary for producing one product. Labor cost CostB_{x,y} necessary for producing the product x in the production lot y can be given by the following equation:

$${CostB}_{x , y} = {\sum }_{i = 1}^{{B}_{x \text{-} all}} \{ {B}_{i} \times {N}_{i} \} \qquad [ Math . 3 ]$$

where

Bₓ₋ₐₗₗ: total number of parts used in product x,

i: part number,

Bᵢ: unit price of i-th part, and

Nᵢ: the number of i-th parts used in product.

The total cost is calculated as a sum of the labor cost, the equipment/management cost, and the product cost incurred in producing one product. Total cost CostAll_{x,y} necessary for producing the product x in the production lot y can be given by the following equation.

CostAll_{x,y}=CostH_{x,y}+CostM_{x,y}+CostB_{x,y} [math. 4]

The throughput represents a quantity of products produced per unit time. Throughput TH_{x,y} when producing the product x in the production lot y can be given by the following equation:

$${TH}_{x , y} = \frac{{P}_{x , y}}{{T}_{x , y}} \qquad [ Math . 5 ]$$

where

P_{x,y}: quantity of products x produced in production lot y, and

T_{x,y}: production time of production lot y in which product x is produced.

The production volume represents a quantity of products x produced during a certain period. A quantity Pₓ of products x produced during a certain month can be given by the following equation:

$${P}_{x} = {\sum }_{y = 1}^{{Y}_{month}} \{ {P}_{x , y} \} \qquad [ Math . 6 ]$$

where

Y: production lot number of certain month,

Yₘₒₙₜₕ: number of production lots of certain month, and

P_{x,y}: quantity of products x produced in production lot

The KPI is respectively calculated with respect to production draft plans on the basis of the resource allocation schemes E1 to E3 shown in FIG. 8 and displayed on a display screen 113 of the display unit 112 shown in FIG. 1.

By referring to the KPI displayed on the display screen 113, the user can confirm that the labor cost of the production draft plan on the basis of the resource allocation scheme E2 is lower than the labor cost of the production draft plan on the basis of the resource allocation scheme E1 and that the labor cost of the production draft plan on the basis of the resource allocation scheme E3 is lower than the labor cost of the production draft plan on the basis of the resource allocation scheme E2.

In addition, the user can instruct the production plan adjustment receiving unit 109 to adjust the production plan on the basis of a result of referring to the KPI displayed on the display screen 113. The production plan adjustment receiving unit 109 can refer to production plan adjustment patterns when adjusting the production plan.

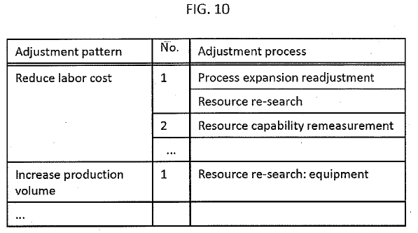

FIG. 10 is a diagram showing an example of a production plan adjustment pattern of the resource planning apparatus according to the first embodiment.

In FIG. 10, an adjustment process for increasing or reducing the KPI is registered in the production plan adjustment pattern. For example, adjustment processes of process expansion adjustment and resource re-search and an adjustment process of resource capability remeasurement are registered with respect to reducing labor cost, and an adjustment process of resource re-search: equipment is registered with respect to increasing production volume.

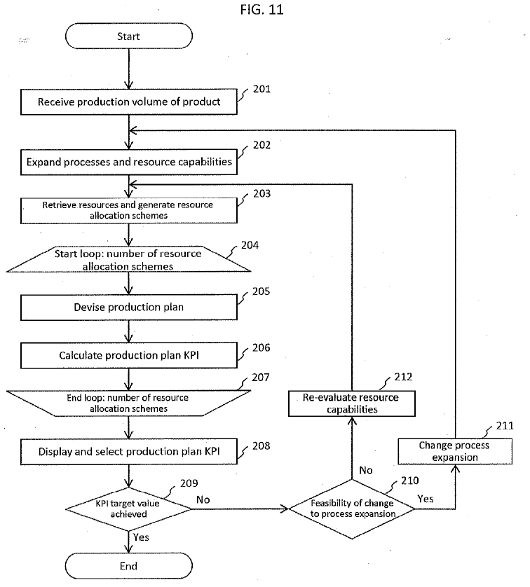

FIG. 11 is a flow chart showing operations of the resource planning apparatus according to the first embodiment.

In FIG. 11, in step 201, the product production volume receiving unit 103 shown in FIG. 1 receives a production volume of the product scheduled to be produced. For example, 100 is received as the production volume of a product with a product number of product A.

Next, in step 202, the resource expanding unit 104 expands processes and resources necessary for producing the product. For example, from the product resource expansion table shown in FIG. 2, with respect to the product A, the resource expanding unit 104 expands that a resource with the machining capability 1 is necessary for the process A1, a resource with the assembly capability 2 is necessary for the process A2, and a resource with the inspection capability 3 is necessary for the process A3.

Next, in step 203, the resource allocation scheme generating unit 105 retrieves resources necessary for producing the product and generates a resource allocation scheme. For example, from the resource capability table shown in FIG. 4A, the resource allocation scheme generating unit 105 retrieves the worker p with respect to the machining capability 1, the worker q with respect to the assembly capability 2, and the worker r with respect to the inspection capability 3, and generates the resource allocation scheme El shown in FIG. 5.

Next, in step 204, loops corresponding to the number of resource allocation schemes generated by the resource allocation scheme generating unit 105 are started. In this example, since there is only one resource allocation scheme E1, only one loop is started.

Next, in step 205, on the basis of the resource allocation scheme generated by the resource allocation scheme generating unit 105, the production plan devising unit 106 expands time during which each resource performs work and generates a schedule plan necessary for producing the necessary quantity of products. For example, on the basis of the resource allocation scheme E1 shown in FIG. 5, the production plan devising unit 106 expands time during which the workers p, q, and r perform work and generates a schedule plan necessary for producing the necessary quantity of products.

Next, in step 206, the production plan KPI calculating unit 107 calculates the KPI with respect to the production plan devised by the production plan devising unit 106. For example, the production plan KPI calculating unit 107 calculates the KPI such as labor cost with respect to the resource allocation scheme E1 shown in FIG. 5.

Next, in step 207, when there is a next resource allocation scheme, the processing returns to step 204, but when there is no next resource allocation scheme, the processing advances to step 208. In this example, since there is only one resource allocation scheme E1, the processing advances to step 208.

Next, in step 208, the display unit 112 displays the KPI such as the labor cost with respect to the resource allocation scheme generated by the resource allocation scheme generating unit 105 on the display screen 113. In this example, since there is only one resource allocation scheme E1, the display unit 112 displays the KPI such as the labor cost with respect to the resource allocation scheme E1 on the display screen 113. In addition, by referring to the KPI displayed on the display screen 113, the user can check whether or not the KPI is as expected. When there is a KPI that is not as expected, by selecting the KPI, the user can cause the production plan adjustment receiving unit 109 to select an adjustment process with respect to the KPI.

Next, in step 209, the production plan KPI determining unit 108 compares the KPI calculated by the production plan KPI calculating unit 107 with a target value and determines whether or not the target value has been achieved. When the KPI calculated by the production plan KPI calculating unit 107 has achieved the target value, the processing is ended, but when the KPI calculated by the production plan KPI calculating unit 107 has not achieved the target value, the processing advances to step 210. For example, as shown in FIG. 9, the labor cost with respect to the resource allocation scheme E1 is 130. Therefore, when the target value of the labor cost is 120 or less, the production plan KPI determining unit 108 determines that the KPI calculated by the production plan KPI calculating unit 107 has not achieved the target value and advances to step 210.

Next, in step 210, the production plan adjustment receiving unit 109 determines feasibility of a change to process expansion. When a change to process expansion is feasible, the processing advances to step 211, but when a change to process expansion is not feasible, the processing advances to step 212. For example, when the production plan adjustment receiving unit 109 finds that the processes A2 and A3 can be integrated into the process A4 in the product resource expansion table shown in FIG. 2 on the basis of another table or an original design drawing, the production plan adjustment receiving unit 109 advances to step 211.

Next, in step 211, the process expansion adjusting unit 111 updates the product resource expansion table by adjusting process expansion and returns to step 202. For example, the process expansion adjusting unit 111 changes the product resource expansion table shown in FIG. 2 to the product resource expansion table shown in FIG. 3 and returns to step 202.

On the other hand, when it is determined in step 210 that a change to process expansion is not feasible, the resource capability measuring unit 110 re-evaluates resource capabilities. For example, the resource capability measuring unit 110 updates the resource capability data shown in FIG. 4A to the resource capability data shown in FIG. 4B and returns to step 203.

Upon returning to step 202, the resource expanding unit 104 expands resources necessary for producing the product A, and in step 203, the resource allocation scheme generating unit 105 generates, for example, the resource allocation schemes E2 and E3 shown in FIG. 8. Subsequently, once the loop is repeated twice in step 204, in step 205, the production plan devising unit 106 devises production plans with respect to the resource allocation schemes E2 and E3, and in step 206, the production plan KPI calculating unit 107 calculates the KPI with respect to the resource allocation schemes E2 and E3.

In addition, the display unit 112 displays the KPI such as the labor cost with respect to the resource allocation schemes E2 and E3 together with that of the resource allocation scheme E1 on the display screen 113 shown in FIG. 9. As shown in FIG. 9, the labor cost with respect to the resource allocation scheme E2 is 100, and the labor cost with respect to the resource allocation scheme E3 is 80. Therefore, when the production plan KPI determining unit 108 determines that the labor cost is under 120 and the target value has been achieved in the resource allocation schemes E2 and E3, the production plan KPI determining unit 108 ends the processing.

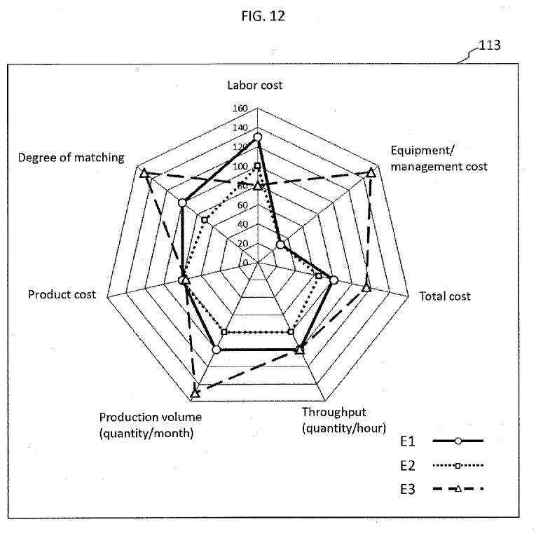

FIG. 12 is a diagram showing a display example of a production plan KPI of the resource planning apparatus according to a second embodiment.

As shown in FIG. 12, examples of the production plan KPI may include a KPI related to a worker resource in addition to the KPI shown in FIG. 9 which contributes to business management. An example of the KPI related to a worker resource is a degree of matching. The degree of matching represents a degree of matching between contents of allocated work and a capability of a worker resource and is an indicator that indicates whether a worker is performing appropriate work that is commensurate with the worker's capability. A degree of matching MatctH_{x,y} when producing the product x in the production lot y can be given by the following equation:

$${MatctH}_{x , y} = \frac{{\sum }_{j = 1}^{M} \vert {HC}_{J} - {WC}_{J} \vert}{M} \qquad [ Math . 7 ]$$

where

j: worker resource number,

M: total number of worker resources,

HCⱼ: work capability value of worker resource number j, and

WCⱼ: necessary work capability value of process to which worker resource number j is allocated.

Including a KPI related to a worker resource in addition to a KPI that contributes to business management enables an effect received by a resource to be shown on the display screen 113.

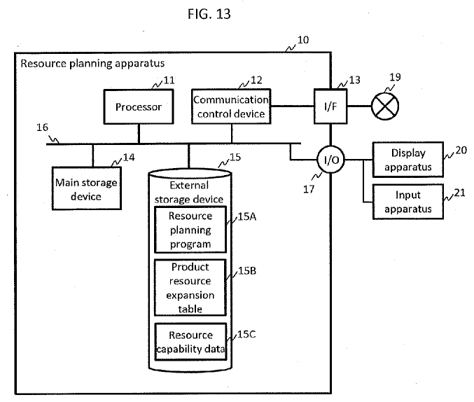

FIG. 13 is a block diagram showing a hardware configuration example of the resource planning apparatus shown in FIG. 1. In FIG. 13, a resource planning apparatus 10 includes a processor 11, a communication control device 12, a communication interface 13, a main storage device 14, and an external storage device 15. The processor 11, the communication control device 12, the communication interface 13, the main storage device 14, and the external storage device 15 are coupled to each other via an internal bus 16. The main storage device 14 and the external storage device 15 can be accessed from the processor 11.

In addition, a display apparatus 20 and an input apparatus 21 are provided outside of the resource planning apparatus 10. The display apparatus 20 and the input apparatus 21 are coupled to the internal bus 16 via an input/output interface 17. The input apparatus 21 may be a pointing device such as a mouse, a keyboard, or a touch panel.

The processor 11 is hardware responsible for operation control of the entire resource planning apparatus 10. The main storage device 14 can constituted by, for example, a semiconductor memory such as an SRAM or a DRAM. A program currently being executed by the processor 11 can be stored in the main storage device 14 or a work area used by the processor 11 to execute the program can be provided in the main storage device 14.

The external storage device 15 is a storage device having a large storage capacity and examples thereof include a hard disk apparatus and an SSD (Solid State Drive). The external storage device 15 is capable of holding executable files of various programs and data to be used when executing the programs. A resource planning program 15A, a product resource expansion table 155, and resource capability data 15C can be stored in the external storage device 15. The resource planning program 15A may be software that can be installed in the resource planning apparatus 10 or may be built into the resource planning apparatus 10 as firmware.

The communication control device 12 is hardware equipped with a function for controlling communication with the outside. The communication control device 12 is coupled to a network 19 via the communication interface 13. The network 19 may be a WAN (Wide Area Network) such as the Internet, a LAN (Local Area Network) such as WiFi or the Ethernet (registered trademark), or a combination of a WAN and a LAN.

The input/output interface 17 converts data input from the input apparatus 21 into a data format that can be processed by the processor 11 and converts data output from the processor 11 into a data format that can be processed by the display apparatus 20.

When the processor 11 reads the resource planning program 15A to the main storage device 14 and executes the resource planning program 15A, processes necessary for producing a product and resource capabilities necessary for resources to execute the processes can be expanded, resources having the resource capabilities can be allocated to the processes, and a production plan of the product can be devised on the basis of the resources allocated to the respective processes. The processor 11 can refer to the product resource expansion table 15B when expanding the processes necessary for producing the product and the resource capabilities necessary for the resources to execute the processes. The processor 11 can refer to the resource capability data 15C when allocating the resources having the resource capabilities to the processes. At this point, the resource planning program 15A can realize the functions of the resource expanding unit 104, the resource allocation scheme generating unit 105, and the production plan devising unit 106 shown in FIG. 1.

It should be noted that the execution of the resource planning program 15A may be shared among a plurality of processors or computers. Alternatively, the processor 11 may be configured to instruct a cloud computer or the like via the network 19 to execute all of or a part of the resource planning program 15A and to receive an execution result thereof.

It is to be understood that the present invention is not limited to the embodiments described above and is intended to cover various modifications. For example, the embodiments presented above have been described in detail in order to provide a clear understanding of the present invention, and the present invention is not necessarily limited to embodiments including all of the components described above. In addition, a part of components of a certain embodiment can be replaced with components of another embodiment, and components of another embodiment can be added to components of a certain embodiment. Furthermore, a part of the components of each embodiment can be added to, deleted from, or replaced with other components. Moreover, the respective components, functions, processing units, processing means, and the like described above may be partially or entirely realized by hardware by, for example, designing with integrated circuits or the like.

What is claimed is:

1. A resource planning apparatus, comprising:
a resource expanding unit configured to expand processes necessary for producing a product and resource capabilities necessary for resources to execute the processes;
a resource allocation scheme generating unit configured to allocate resources having the resource capabilities expanded by the resource expanding unit to the processes; and
a production plan devising unit configured to devise a production plan of the product on the basis of the resources allocated to the processes.

2. The resource planning apparatus according to claim 1, further comprising
a product production volume receiving unit configured to receive a production volume of the product together with a delivery date, wherein
the resource expanding unit is configured to expand the resource capabilities so that the product can be produced in the production volume by the delivery date.

3. The resource planning apparatus according to claim 1, further comprising:
a product/process expanded data storage unit configured to store data indicating processes necessary for producing the product and data indicating resource capabilities necessary for resources to execute the processes; and
a resource capability data storage unit configured to store data indicating resource capabilities of resources to execute the processes.

4. The resource planning apparatus according to claim 3, wherein
the resource expanding unit is configured to expand, on the basis of data stored in the product/process expanded data storage unit, processes necessary for producing the product and resource capabilities necessary for resources to execute the processes, and
the resource allocation scheme generating unit is configured to allocate, on the basis of data stored in the resource capability data storage unit, resources having the resource capabilities expanded by the resource expanding unit to the processes.

5. The resource planning apparatus according to claim 1, further comprising:
a production plan KPI (Key Performance Indicator) calculating unit configured to calculate a KPI related to performance of the production plan; and
a production plan adjustment receiving unit configured to receive a change or a determination of the production plan on the basis of a determination result of the KPI.

6. The resource planning apparatus according to claim 1, further comprising
a process expansion adjusting unit configured to adjust processes necessary for producing the product as expanded by the resource expanding unit.

7. The resource planning apparatus according to claim 6, wherein
the resource expanding unit is configured to expand processes necessary for producing the product and resource capabilities necessary for resources to execute the processes on the basis of an adjustment result of the processes necessary for producing the product by the process expansion adjusting unit.

8. The resource planning apparatus according to claim 1, further comprising:
a resource capability measuring unit configured to measure resource capabilities necessary for resources to execute the processes.

9. The resource planning apparatus according to claim 8, wherein
the resource allocation scheme generating unit is configured to allocate, on the basis of a measurement result of the resource capabilities by the resource capability measuring unit, resources having the resource capabilities expanded by the resource expanding unit to the processes.

10. A resource plan visualization method, comprising:
devising a production plan of a product on the basis of resources allocated to processes necessary for producing the product;
calculating a KPI related to performance of the production plan; and
displaying the calculated KPI.

11. The resource plan visualization method according to claim 10, wherein
the KPI includes at least any one of labor cost, product cost, a production volume, equipment/management cost, and total cost.

12. The resource plan visualization method according to claim 10, wherein
an effect received by the resources is displayed as the KPI.
